(19) United States
(12) Patent Application Publication
(10) Pub. No.: US 2009/0167782 A1
(43) Pub. Date: Jul. 2, 2009

(54) CORRECTION OF COLOR DIFFERENCES IN MULTI-SCREEN DISPLAYS

(75) Inventors: Branko Petljanski, Woodland Hills, CA (US); James Bernard Pearman, Glendale, CA (US)

Correspondence Address: MORRISON & FOERSTER, LLP, 555 WEST FIFTH STREET, SUITE 3500, LOS ANGELES, CA, 90013-1024, US

(73) Assignee: PANAVISION INTERNATIONAL, L.P., Woodland Hills, CA (US)

(21) Appl. No.: 11/968,628

(22) Filed: Jan. 2, 2008

(51) Int. Cl. G09G 5/06

(52) U.S. Cl. 345/601

(57) ABSTRACT

The calibration (e.g. color correction and/or equalization) of one or more display devices in an automated fashion using feedback obtained directly from the display devices, without requiring any manual or subjective evaluation, is disclosed. A sensor associated with a particular display device automatically measures certain characteristics of the display device, and feeds back calibration information to an image processor at the input to the display device. Based on the feedback, the image processor adjusts the characteristics of the display device to match a reference characteristic. When multiple sensors are used with multiple display devices and image processors, substantially uniform display characteristics and matching of the multiple display devices is possible.

### FIELD OF THE INVENTION

Embodiments of the invention relate to the calibration of display devices, and more particularly, to the automated monitoring and calibration of one or more display devices to obtain image uniformity.

### BACKGROUND OF THE INVENTION

Modern electronic display devices utilize different technologies such as cathode ray tube (CRT), liquid crystal display (LCD), plasma, digital light processing (DLP), and the like. Given the same input signal, each of these displays may produce a different “color temperature,” white point and color balance (color characteristics) due to fundamental differences in how the displayed image is generated. In addition, assembly tolerances, material variations, environmental effects (e.g. temperature, humidity), and component aging can result in different image color characteristics on two different display devices of the same technology, even if they were produced from the same batch of manufactured displays.

Because of these differences in color characteristics, obtaining uniform and desired color characteristics has always been a challenge to overcome. While the problem of adjusting a display device to obtain a desired color characteristic is applicable to a single display device, the problem becomes even more acute when multiple display devices are used together to form a larger display, where accurate color matching is desired.

Multi-screen display solutions are becoming more and more common for large image and video presentations. For example, multiple displays may be used to form a large display intended to be seen by passersby, each display showing only a portion of an overall image. Ultra-thin bezels make it possible to join multiple displays (image stitching) with only a very small, almost seamless gap between them. Multiple display devices may also be used to surround a viewer to create an “immersive” effect, such as in flight simulators, “virtual” meeting rooms, and “surround”-type games and entertainment systems. Additionally, multiple displays may be used together where each display shows the same image for artistic effect, or completely different images for a functional and/or aesthetic purpose (e.g. multiple television channels being displayed simultaneously in the background of a television newscast).

FIG. 1 illustrates a simple exemplary two display device system 100 depicting the aforementioned problem of color matching in multiple display systems. In FIG. 1, an input image 102 may be split into two separate images 104 and 106, and displayed on two separate display devices 108 and 110, respectively. However, due to one or more of the differences described above, display device 110 may have a different color characteristic than display device 108 (shown in FIG. 1 as shaded image 110).

Any display device can be viewed as a nonlinear system, which can be difficult to model. Therefore, the exact color behavior of a display device with respect to a given input signal can be difficult to predict. The nonlinearity of each display device additionally emphasizes the difference in colors between two display devices.

It has been shown that the human visual system (HVS) is very sensitive to color and intensity differences. Even an untrained observer can easily notice the color difference between adjacent monitors showing the same image, such as in a consumer electronics store where numerous televisions may be on display and showing the same image. Thus, the equalization of color differences is important to both display device manufacturers and those who set up, maintain, and utilize one or more display devices.

In order to compensate for the differences in the transfer functions between individual display devices, a precise transfer function of each display device must be known. However, determining a transfer function for each display device is complex and often impractical. In addition, because the characteristics of a display device change with various parameters (e.g., time, temperature), the transfer function of the display device is not constant, but rather is a function of those parameters.

One conventional methodology for performing color correction and/or equalization involves constantly monitoring and manually adjusting one or more display devices until the desired color temperature is achieved, or in the case of multiple displays, until an observer cannot perceive the color difference between the displays. However, this is a slow, tedious and daunting task. To perform manual correction, a person may have to attach a sensor to the display device, connect the sensor to a measurement device, take a reading, attempt to manually correct the color, and then take another reading to verify the correction had its intended effect.

Another conventional methodology for adjusting the color characteristics of a single display device is to insert a compensating device at the input to the display device. The compensating device, such as an image processor, compensates for the differences in the transfer functions between individual display devices.

FIG. 2 illustrates an exemplary image processor 216 coupled between a digital video source 200 and a display device 204. The image processor 216 adjusts the digital output signal 202 by performing a series of procedural processing steps (adjusting parameters such as gamma, saturation, gain, contrast, pedestal, offset and the like). Among other things, the image processor 216 can adjust to color of a display device to match a reference colorimetry.

One conventional processing step utilized within image processors is the use of so-called three-dimensional (3D) look-up tables (LUTs). Input video image data can be applied to a 3D LUT to generate output video image data having video image characteristics specific to that particular 3D LUT. For example, a 3D LUT can be used to apply a certain amount of color correction to a digital video signal.

FIG. 3 graphically represents an exemplary 3D LUT 300. The term “3D” is used because three axes can be used to represent the colors red (R), green (G) and blue (B). For example, in FIG. 3 the color R is represented along the x-axis, the color G is represented along the y-axis, and the color B is represented along the z-axis. Although the digital output signal from the camera may provide a resolution of 10 bits (1024 values) per color, for example, generating an exhaustive table for all three colors would amount to a table containing 1024×1024×1024 entries, or over one billion entries. Therefore, in practical applications, the 3D LUT 300 may be comprised of a lower resolution table with a fewer number of entries, such as 17×17×17 entries, or less than 5000 entries. Each entry contains a triplet of values x′, y′ and z′ for each color R, G and B, respectively, where x′, y′ and z′ range from 0 to 1023 (a 10-bit value), for example.

When the actual 10-bit digital output signal values x, y, and z for each color R, G and B, respectively, are applied to the 3D LUT, where x, y and z range from 0 to 1023, the 3D LUT generates modified digital output signal values x′, y′ and z′. Note, however, that in embodiments in which the 3D LUT is a lower resolution table (e.g. 17×17×17 instead of 1024×102×1024), the image processor may perform extrapolation on entries in the 3D LUT to obtain accurate x′, y′ and z′ values.

FIG. 4 illustrates a series of processing steps performed within an exemplary image processor to perform image processing on a pixel-by-pixel basis (as opposed to spatial or temporal filtering or processing). In the example of FIG. 4, the original digital output signal 400 comprised of n-bit R, G and B signals x, y and z are fed into a 3D LUT 402, which may be utilized to perform color conversion and generated modified digital output signal values x′, y′ and z′ as described above. The color converted digital output signal may then be fed into a one-dimensional (1D) LUT 404, which may be used for a number of purposes such as gain adjustments, black level adjustments, or gamma conversion. Note that the 1D LUT 404 may be the only processing step needed if the image processor only adjusted the intensity of the image.

Next, the digital output signal may be gamma-converted in gamma (gain) processing block 406, and then fed into a matrix 408 which can perform intentional cross-contamination of one color with another (i.e. mixing of colors), adjust gain, saturation, and the like. The digital output signal may then be fed into a saturation processing block 410, to change the saturation of the image, and then to another one-dimensional (1D) LUT 412 to perform additional color conversion. The result of all image processing steps is a modified digital output signal values x″, y″ and z″ (see reference character 414).

While the image processor described above is suitable for adjusting the color characteristics of a single display device, any adjustments to the image processing steps described above are performed without benefit of any automated feedback from the output of the display device itself. Moreover, any color correction performed by the image processing steps described above is performed without consideration for any other display devices, or any preferred colorimetric reference standard.

Therefore, there is a need to perform calibration of one or more display devices in an automated fashion using feedback obtained directly from the display devices, without requiring any manual or subjective evaluation.

### SUMMARY OF THE INVENTION

Embodiments of the invention are directed to performing calibration (e.g. color correction and/or equalization) of one or more display devices in an automated fashion using feedback obtained directly from the display devices, without requiring any manual or subjective evaluation. A sensor associated with a particular display device automatically measures certain characteristics of the display device, and feeds back calibration information to an image processor at the input to the display device. Based on the feedback, the image processor adjusts the characteristics of the display device to match a reference characteristic. When multiple sensors are used with multiple display devices and image processors, substantially uniform display characteristics and matching of the multiple display devices is possible.

The calibration that may be achieved includes color and brightness correction of digital video signals and other types of digital images (e.g. images from digital photography). Calibration may be achieved over multiple display devices, with each display device either showing (1) only a portion of an overall image, (2) the same image for artistic effect, or (3) completely different images for a functional and/or aesthetic purpose (e.g. multiple television channels being displayed simultaneously in the background of a television newscast). In addition, a single display to be maintained at a particular reference display characteristic can be calibrated.

In a multi-display device system including devices displaying different portions of the input image, a digital input image is first divided into N bitstreams by an image splitter. Each bitstream is fed into a different image processor, which generates a modified bitstream. Each modified bitstream, which represents at least a portion of the complete digital input image, is fed into a different display device. A different sensor associated with each display device measures certain display characteristics of the display device and sends feedback information back to the image processor associated with that display device. The image processor then modifies its 3D LUT in accordance with the feedback signal.

The image processor has a digital image input for receiving digital image data when the image processor is being used in its normal mode, which is to perform image processing on incoming digital image data. Within image processor is a test signal generator which is capable of automatically generating digital test patterns when the image processor is being used for calibration. One or more test patterns may be presented in one or more pixels over a number of frames. Either the digital image input or the test signal generator or combinations thereof can be processed by an image processing block. The output of the internal image processing block is sent out of the image processor via a digital image output. A feedback input port connectable to an external sensor can be used to provide a representation of the display characteristics of a portion of the display device to the internal image processing logic. The internal image processing logic can compare the display characteristics from the feedback input to the test signal from the test signal generator to compute a “correction” 3D LUT that compensates for the changes produced by the display device.

The sensor may be located in front of a portion of the display device, either in the visible area of the display device or hidden in the bezel of the display device. If the sensor is located in the visible area, it may be located in an extreme corner of the display device where the sensor causes that corner to have a rounded appearance. The sensor may be discrete, attached to the front of the display and connected via wiring, or it may be integrated into the bezel or behind the bezel. Alternatively, the sensor may be a remote sensor that focuses on a portion of the display using a telescoping lens, for example. This embodiment may be useful in large, stadium-style display devices where it is convenient to locate all sensors at a location remote from the display devices.

### BRIEF DESCRIPTION OF THE DRAWINGS

FIG. 1 illustrates a simple exemplary two display device system depicting the problem of color matching in multiple display systems.

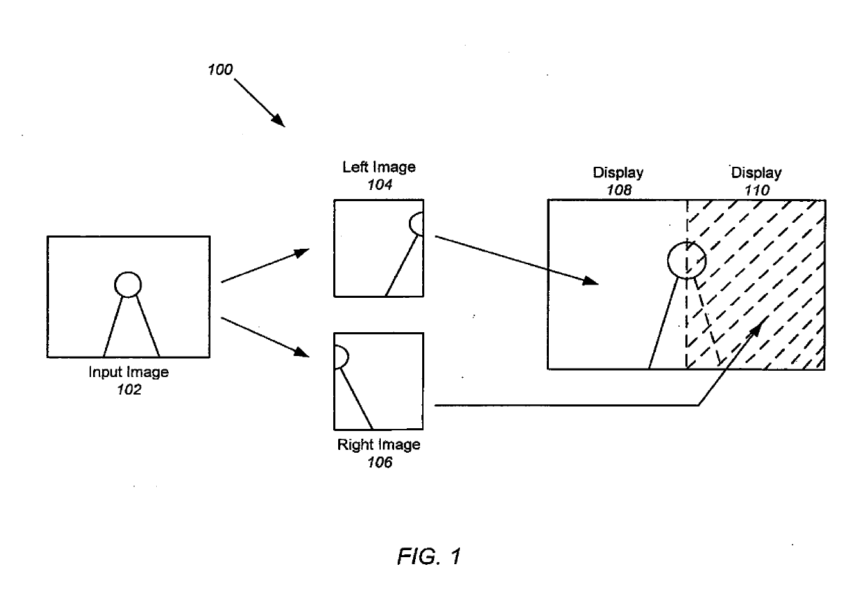

FIG. 2 illustrates an exemplary digital video system including an image processor coupled between a digital video source and a display device.

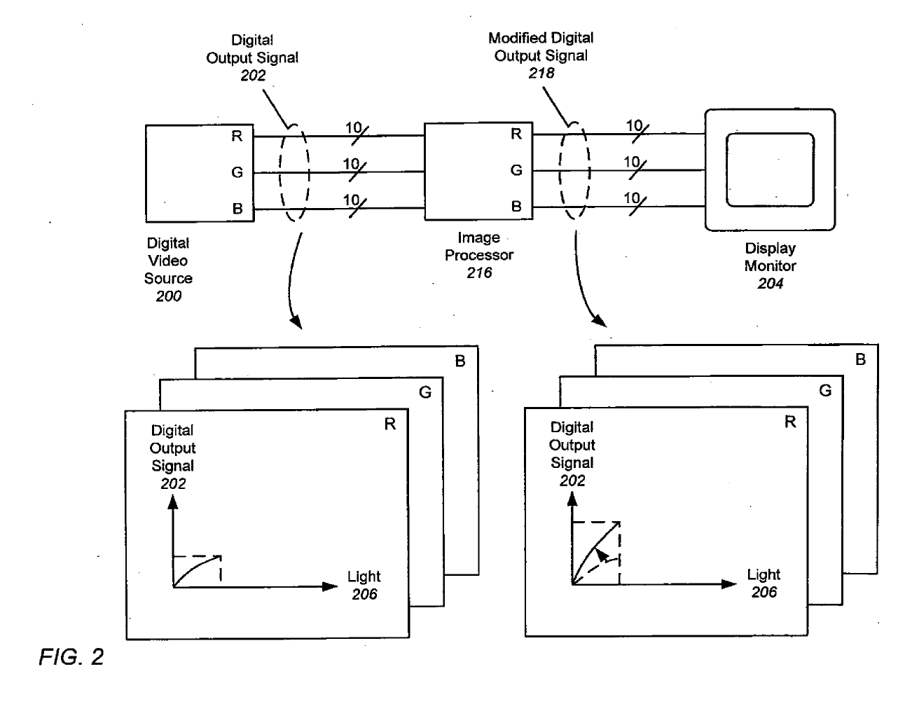

FIG. 3 illustrates an exemplary 3D LUT.

FIG. 4 illustrates a series of exemplary processing steps performed within an image processor for performing color conversion on a pixel-by-pixel basis.

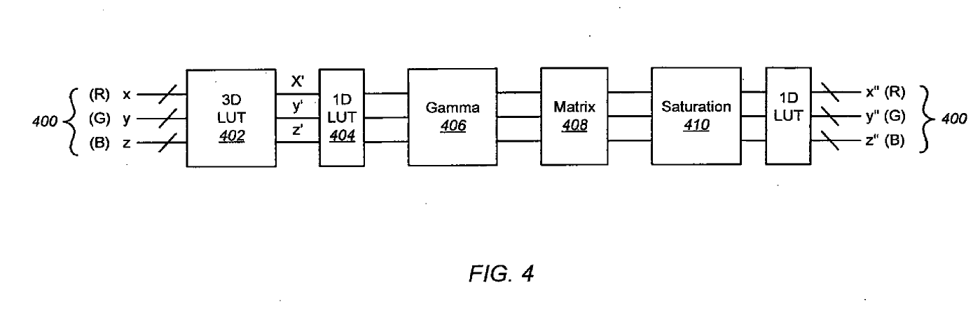

FIG. 5 illustrates a multi-display device system according to embodiments of the invention.

FIG. 6a illustrates an exemplary image processor according to embodiments of the invention.

FIG. 6b illustrates an image processor in an exemplary system environment according to embodiments of the invention.

FIG. 7 illustrates the position of an exemplary sensor on a display device according to embodiments of the invention.

FIG. 8 illustrates an exemplary hardware block diagram of the image processor according to embodiments of the invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

Embodiments of the invention are directed to performing calibration (e.g. color correction and/or equalization) of one or more display devices in an automated fashion using feedback obtained directly from the display devices, without requiring any manual or subjective evaluation. A sensor associated with a particular display device automatically measures certain characteristics of the display device, and feeds back calibration information to an image processor at the input to the display device. Based on the feedback, the image processor adjusts the characteristics of the display device to match a reference characteristic. When multiple sensors are used with multiple display devices and image processors, substantially uniform display characteristics and matching of the multiple display devices is possible.

Although some embodiments of the invention may be described herein in terms of color correction of digital video signals, embodiments of the invention are also applicable to other types of correction (e.g. brightness) and other types of digital images (e.g. images from digital photography).

Furthermore, although some embodiments of the invention may be described herein in terms of multiple display devices with each display device showing only a portion of an overall image, embodiments of the invention are applicable to multiple display devices with each display showing the same image for artistic effect, or completely different images for a functional and/or aesthetic purpose (e.g. multiple television channels being displayed simultaneously in the background of a television newscast).

In addition, embodiments of the invention are also applicable to a single display that is to be maintained at a particular reference display characteristic. For example, a display calibration system can be built into a single display device to maintain a particular reference color characteristic over time as the display ages. In another example, because DVDs are generally mastered for a particular type of display (e.g. plasma), in order to ensure that the DVD will produce desired color characteristics when played back on another type of display (e.g. LCD), the calibration system according to embodiments of the invention could be used to automatically calibrate color from a DVD. The DVD itself may have test patterns for calibrating the color. In such embodiments, no test signal generator may be needed.

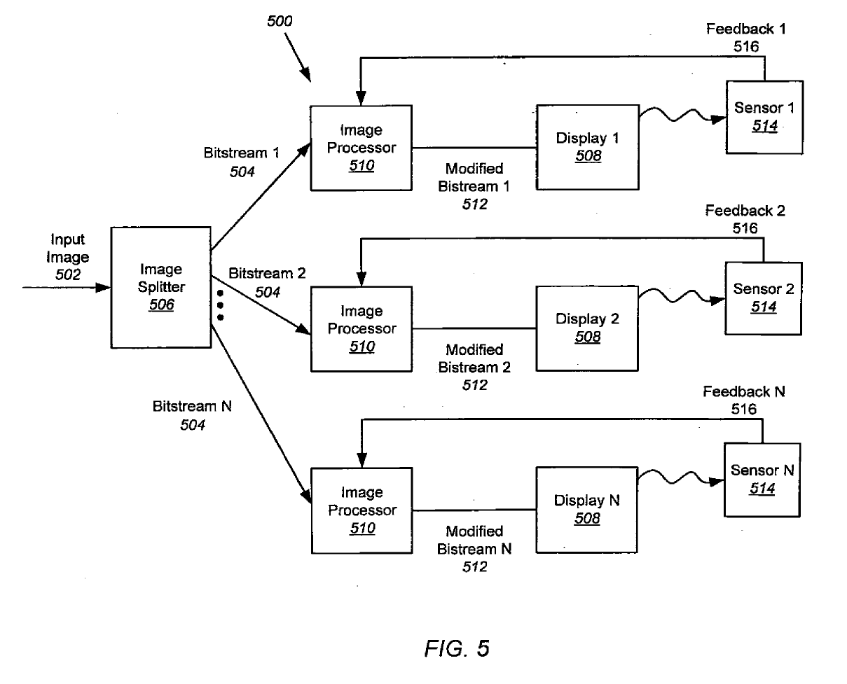

FIG. 5 illustrates a multi-display device system 500 according to embodiments of the invention. A digital input image 502 is first divided into N bitstreams 504 by an image splitter 506. Image splitter 506 is well-known to those skilled in the art (e.g. a quad-splitter) and will not be discussed further. It should be understood that image splitter 506 is only needed when the N display devices 508 are intended to display a different portion of the input image 502. If the images are the same on all displays, then the image splitter 506 can be replaced with a distribution amplifier. Each bitstream 504 is fed into a different image processor 510, which generates a modified bitstream 512. Each modified bitstream 512, which represents at least a portion of the complete digital input image 502, is fed into a different display device 508. A different sensor 514 associated with each display device 508 measures certain display characteristics of the display device and sends feedback information 516 back to the image processor 510 associated with that display device. The image processor 510 then modifies its 3D LUT in accordance with the feedback signal 516.

As mentioned above, image processor 510 calibrates displayed images based on measurements from the sensor 514. Image processor 510 can be functionally similar to the image processor disclosed in commonly owned U.S. patent application Ser. No. 11/715,772, entitled “Generation of 3D Look-Up Tables For Image Processing Devices,” filed on Mar. 7, 2007, the contents of which are incorporated by reference herein. The image processor 510 has a digital input and output e.g. a DVI or SMPTE292 interface and enough memory to store one or more 3D LUTs. The digital interface allows for manipulation of digital images such as inserting test color signals at predetermined spatial and temporal positions. These test signals can be displayed as part of the displayed image and measured by the sensor 514. The image processor 510 can insert these test patterns continuously or periodically. The temporal frequency of the test signals can be based on the predicted change of a display's color characteristic over time.

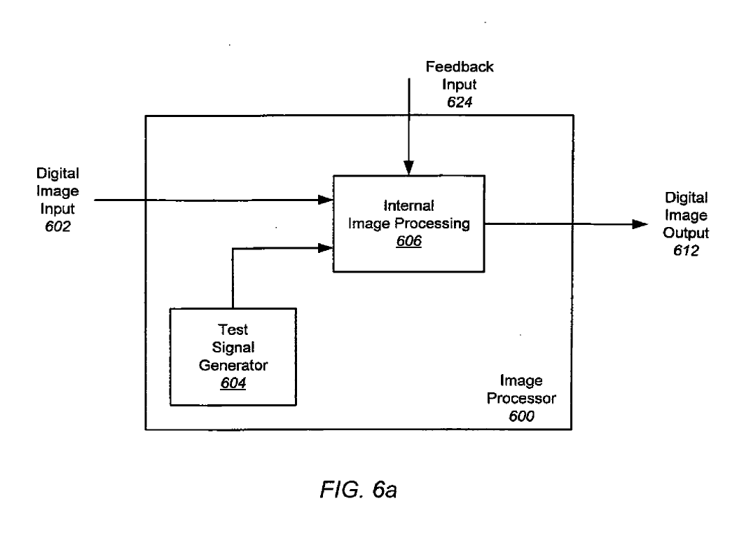

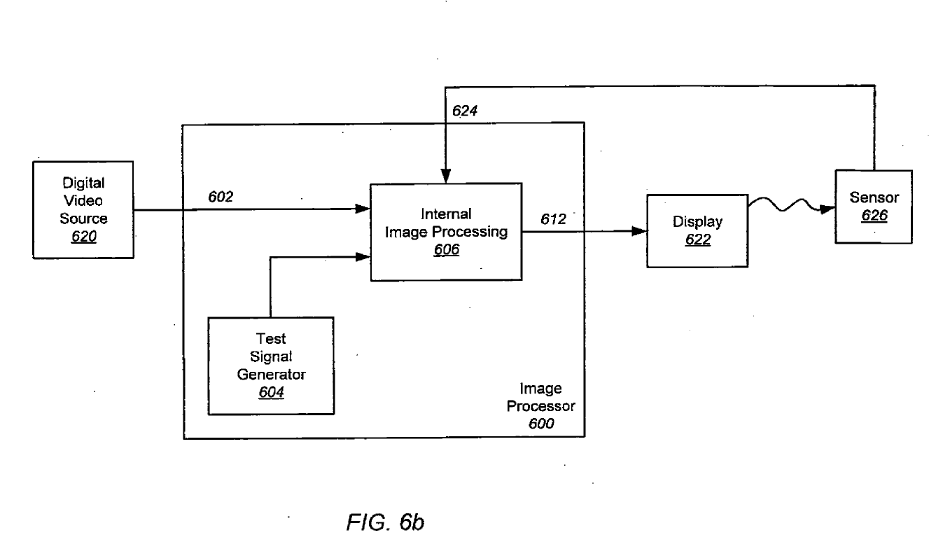

FIG. 6a illustrates an exemplary image processor 600 according to embodiments of the invention. In FIG. 6a, a digital image input 602 is provided for receiving digital image data when the image processor 600 is being used in its normal mode, which is to perform image processing on incoming digital image data. The digital image data may be received from any source capable of providing digital image data.

Within image processor 600 is a test signal generator 604 which is capable of automatically generating digital test patterns when the image processor is being used for calibration. For example, if a 17×17×17 3D LUT is to be generated within internal image processing block 606, the test signal generator 604 may generate 17×17×17=4913 different x, y, z RGB combinations, each representing a different test pattern. One or more test patterns may be presented in one or more pixels over a number of frames. Either the digital image input 602 or the test signal generator 604 or combinations thereof can be processed by the image processing block 606. In embodiments of the invention, the internal image processing logic 606 inserts test patterns from the test signal generator 604 into specific parts (e.g. pixels) of the digital video stream 620, either continuously or at specific times.

The output of the internal image processing block 606 is sent out of the image processor 600 via a digital image output 612. A feedback input port 624 connectable to an external sensor can be used to provide a representation of the display characteristics of a portion of the display device to the internal image processing logic 606. The feedback input port 624 may include any suitable interface circuitry for receiving signals from the external sensor. The internal image processing logic 606 can compare the display characteristics from the feedback input 622 to the test signal from the test signal generator 604 to compute a “correction” 3D LUT that compensates for the changes produced by the display device.

The image processor 600 may be housed in a single enclosure suitable for connection to a single display device. Alternatively, multiple image processors may be housed in a single enclosure suitable for connection to multiple display devices. In such embodiments, a single test signal generator may generate test patterns for each of the multiple image processors. The enclosure could also include the image splitter or distribution amplifier, as needed. Embodiments of the invention could also be contained a circuit board built into a display device itself

In some embodiments of the invention, the sensor may be a small CMOS or CCD sensor that reads and quantifies the output of a least one three-color pixel and transmits results back to the image processor. The sensor according to embodiments of the invention may be small in size (e.g. a line array several millimeters square), occupying only one or more pixels to minimize obstruction of the image being displayed. Such sensors are well-understood by those skilled in the art and will not be discussed in further detail herein.

The sensor may be located in front of a portion of the display device, either in the visible area of the display device or hidden in the bezel of the display device. If the sensor is located in the visible area, it may be located in an extreme corner of the display device where the sensor causes that corner to have a rounded appearance. The sensor may be discrete, attached to the front of the display and connected via wiring, or it may be integrated into the bezel or behind the bezel. Alternatively, the sensor may be a remote sensor that focuses on a portion of the display using a telescoping lens, for example. This embodiment may be useful in large, stadium-style display devices where it is convenient to locate all sensors at a location remote from the display devices.

In some embodiments, the sensor may function as a spectrometer and measure wavelengths of light, and in particular measure R, G and B. Other types of measurements could include brightness and grey scale. In alternative embodiments, the sensor may measure the characteristics of a particular type of display device (e.g. characteristics unique to LCD, plasma, etc.) for matching the spectrograph characteristics of those types of display devices. In other embodiments, the sensor may only measure the intensity of a color pixel, with the spectral characteristic of the sensor being flat or having some known response. Intensity measurements alone can be sufficient because during the measuring process, the image processor has prior knowledge of which color (or combination of colors) is being sent to the one or more test pixels.

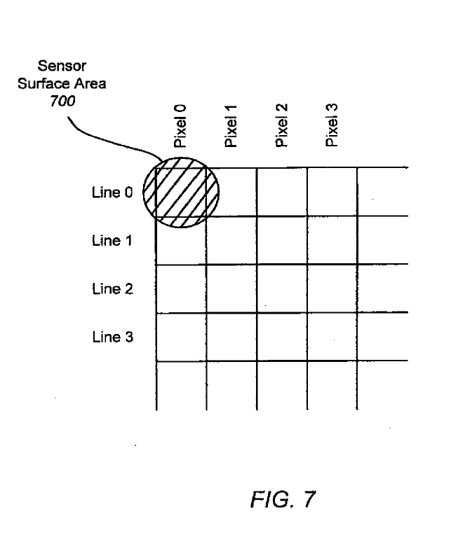

FIG. 7 illustrates the position of an exemplary sensor on a display device according to embodiments of the invention. In FIG. 7, the light-sensitive surface 700 of the sensor completely covers pixel 0 at line 0, which is the pixel through which the test signal will be displayed. However, it should be understood that in general, the pixel size can vary with various display devices, and the sensor may cover more than one pixel or at least portions of adjacent pixels. In the example of FIG. 7, even though the light-sensitive surface 700 of the sensor is perfectly aligned over pixel 0 at line 0, portions of pixel 1 at line 0 and pixel 0 at line 1 are also detected by the light-sensitive surface. Moreover, the light-sensitive surface 700 may not always be perfectly aligned on pixel grids, especially if the sensor is manually placed onto the front of the display device. To ensure that the sensor reads the test signals from only the one or more intended pixels, unwanted pixels can be turned off during the measurement phase. For example, in FIG. 7, the image processor may insert test signals in pixel 0 at line 0, and at the same time, turn off (force to black) pixel 1 at line 0 and pixel 0 at line 1. This will result in a more accurate measurement of color at pixel 0 at line 0.

The spatial position of the test patterns within a frame is dependent on the position of the sensor. For example, if the sensor is placed over a group of pixels at the top left corner of a frame, then the test patterns should be inserted into those pixels. A method for determining the spatial position of the test patterns is needed because the sensor may be placed on the display device at any location, or may be only generally placed in a particular area of the display device. The spatial position can be determined with an automatic test pattern detection process prior displaying any actual image data. In one exemplary embodiment, the image processor can insert a white pixel at various positions within an otherwise black frame until the sensor detects the white pixel.

FIG. 6b illustrates the image processor 600 in an exemplary system environment according to embodiments of the invention. In the example of FIG. 6b, the image processor 600 is connected to the output of a digital video source 620, which provides a digital output signal to the digital image input 602 of the image processor. The digital image input 602 and the test signal generator 604 are both connectable to image processing block 606. The output from the image processing block 606 is then provided at the digital image output 612, which may be connected to a display device 622. A sensor 626 monitors a portion of the display device 622, and provides feedback 628 to the image processing block 606 via feedback input 624.

When the display correction process is being performed, the image processing logic 606 automatically inserts a test pattern from test signal generator 604 into the digital image at a particular location, either continuously or periodically, and generates digital image output data including the test pattern for display on a display device. This test pattern appears at one or more selected pixels on display device 622 that are being monitored by the sensor 626. The sensor 626 then provides a representation of a particular characteristic (e.g. color) detected at those pixels to the image processing block 606. The image processing block 606 compares the display characteristics at the feedback input 624 to the display characteristics of the test pattern from the test signal generator 604, and based on any difference between the two, generates a new entry for a “correction 3D LUT” being maintained in the image processing block. As different test patterns are automatically inserted into the digital image over time, a complete correction 3D LUT is generated without human intervention. This correction 3D LUT thereafter results in the display device 622 producing substantially the same display characteristics as the reference signals generated by the test signal generator 604. In multiple display device systems, each display device will produce a different correction 3D LUT corresponding to the particular characteristics of that display device. However, because each correction 3D LUT is based on the same test patterns, each display device will generate display characteristics that are substantially similar. Multiple display devices with adjusted displays will result in seamless stitching of separate images into one larger image with substantially uniform display characteristics.

As mentioned above, during this display correction process, test patterns are inserted into the digital image. One color may be used in the test pattern at a time, or multiple colors could be used for different pixels if multiple sensors are employed for each display device. The calibration or correction process need not be performed on a per-frame basis. Rather, one test pattern could be inserted into the digital image for one or more consecutive frames, followed by a number of frames for which no test pattern is inserted. Alternatively, the changing test patterns could be continuously inserted into the digital image, but because the number of pixels reserved for display correction processing are small and at the periphery of the displayed image, and may even be hidden from view, this insertion of test patterns should not produce any significant degradation in a user's viewing experience. Depending on the frequency and number of the test patterns, the entire display correction process may take minutes or even hours. In one embodiment, 4096 different colors could be used in the test pattern, one color per frame, and the color correction process could take on the order of a couple of minutes to complete. The display correction process may be performed periodically to account for gradual atmospheric and aging effects, or may be performed only once, or at irregular intervals, primarily to account for manufacturing differences.

In some embodiments of the invention, the calibration process may only set contrast and brightness. For this type of calibration, only black and white pixels are needed. In other embodiments, the calibration process may adjust the amount of R, G and B for any number of combinations. In still other embodiments, the calibration process may adjust grayscale.

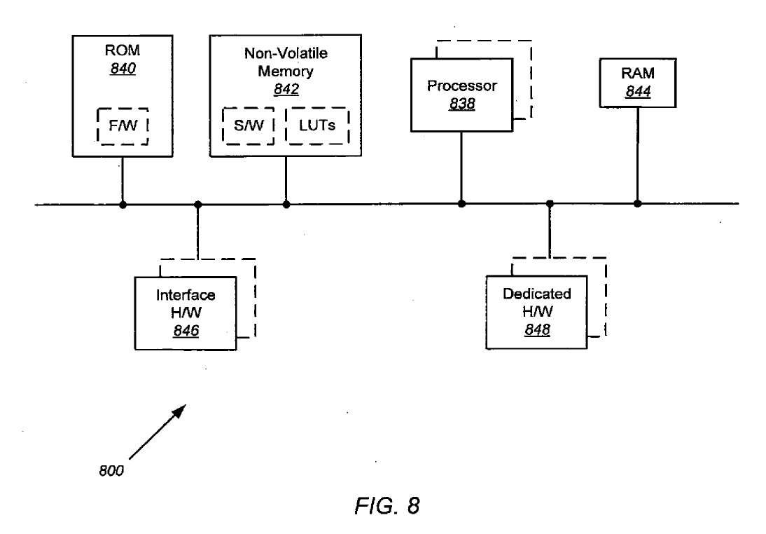

FIG. 8 illustrates an exemplary hardware block diagram of the image processor 800 according to embodiments of the invention. In FIG. 8, one or more processors 838 may be coupled to read-only memory 840, non-volatile read/write memory 842, and random-access memory 844, which may store the boot code, BIOS, firmware, software, and any tables necessary to perform the processing of FIG. 8. In addition, one or more hardware interfaces 846 may be connected to the processor 838 and memory devices to communicate with external devices such as PCs, storage devices and the like. Furthermore, one or more dedicated hardware blocks, engines or state machines 848 may also be connected to the processor 838 and memory devices to perform specific processing operations.

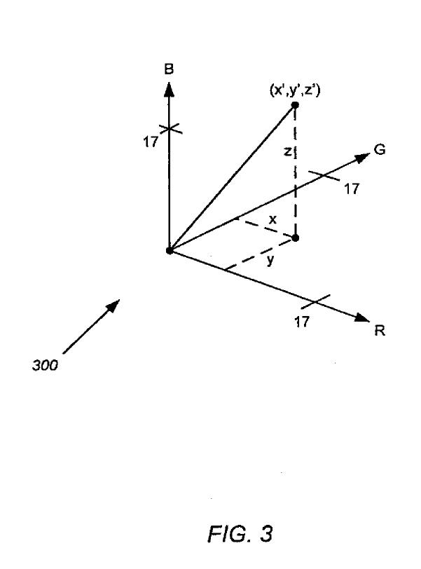

In the example of FIG. 8, hardware interfaces 846 may receive digital image data, test patterns, and feedback information from sensors. Processor 838 and/or dedicated hardware 848 may compare the feedback information against the test patterns, compute a correction 3D LUT, and store the correction 3D LUT in nonvolatile memory 842. Using the correction 3D LUT, the processor 838 and/or dedicated hardware 848 may perform one or more of the processing steps shown in FIG. 3, calibrate digital image data received at hardware interfaces 846, and output modified digital image data at the hardware interfaces for display on a display device.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A system for automatically generating calibrated display characteristics at each of one or more display devices, comprising:
one or more image processing logic blocks, each image processing logic block couplable to a display device and configured for generating modified output image data from input image data; and
a feedback input port within each image processing logic block, the feedback input port configured for receiving a representation of one or more display characteristics detected from the display device;
wherein each image processing logic block is further configured for generating modified output image data including one or more test patterns, receiving the representation of the one or more display characteristics generated from the display device in response to the one or more test patterns, computing a correction three-dimensional lookup table (3D LUT) based on differences between the one or more display characteristics and the one or more test patterns, and adjusting the modified output image data using the correction 3D LUT.

2. The system of claim 1, further comprising one or more test signal generators coupled to one or more of the image processing logic blocks, each test signal generator configured to generate the one or more test patterns for the one or more image processing logic blocks.

3. The system of claim 1, wherein the input image data includes the one or more test patterns.

4. The system of claim 1, further comprising a display device coupled to each of the one or more image processing logic blocks for displaying modified output image data from the image processing logic block.

5. The system of claim 4, further comprising a sensor coupled to each image processing logic block, each sensor in proximity with a display device for detecting test patterns on the display device and providing the representation of the one or more display characteristics to the feedback input port within the image processing logic block.

6. The system of claim 5, wherein the sensor is permanently attached to the display device.

7. The system of claim 1, wherein each image processing logic block is further configured for performing a test pattern detection process to locate the one or more test patterns in the modified output image data.

8. The system of claim 1, further comprising a digital video source coupled to each image processing logic block for providing the input image data to the image processing logic block.

9. The system of claim 8, wherein the digital video source is an image splitter.

10. The system of claim 8, wherein the digital video source is a distribution amplifier.

11. The system of claim 1, wherein the modified output image data including one or more test patterns is generated every frame.

12. The system of claim 1, wherein the modified output image data including one or more test patterns is generated at predetermined intervals.

13. A method for automatically generating calibrated display characteristics at each of one or more display devices, comprising:
for each of the one or more display devices,
receiving input image data,
generating modified output image data from the input image data including one or more test patterns,
receiving a representation of one or more display characteristics detected from the display device in response to the one or more test patterns,
computing a correction three-dimensional lookup table (3D LUT) based on differences between the one or more display characteristics and the one or more test patterns, and
adjusting the modified output image data using the correction 3D LUT.

14. The method of claim 13, further comprising generating the one or more test patterns and inserting the generated one or more test patterns into the input image data.

15. The method of claim 13, wherein the input image data includes the one or more test patterns.

16. The method of claim 13, further comprising placing a sensor in proximity with a display device for detecting test patterns on the display device and providing the representation of the one or more display characteristics.

17. The method of claim 16, further comprising permanently attaching the sensor to the display device.

18. The method of claim 13, further comprising performing a test pattern detection process to locate the one or more test patterns in the modified output image data.

19. The method of claim 13, further comprising providing the input image data from a digital video source.

20. The method of claim 19, wherein the digital video source is an image splitter.

21. The method of claim 19, wherein the digital video source is a distribution amplifier.

22. The method of claim 13, further comprising generating the modified output image data including one or more test patterns every frame.

23. The method of claim 13, further comprising generating the modified output image data including one or more test patterns at predetermined intervals.

24. A system for automatically generating calibrated display characteristics at each of one or more display devices, comprising:
for each of the one or more display devices,
means for receiving input image data,
means for generating modified output image data from the input image data including one or more test patterns,
means for receiving a representation of one or more display characteristics detected from the display device in response to the one or more test patterns,
means for computing a correction three-dimensional lookup table (3D LUT) based on differences between the one or more display characteristics and the one or more test patterns, and
means for adjusting the modified output image data using the correction 3D LUT.

25. A system for automatically generating calibrated display characteristics at each of one or more display devices, comprising:
one or more image processing logic blocks, each image processing logic block couplable to a display device and configured for generating modified output image data from input image data;
a feedback input port within each image processing logic block, the feedback input port configured for receiving a representation of one or more display characteristics detected from the display device;
a display device coupled to each of the one or more image processing logic blocks for displaying modified output image data from the image processing logic block;
a sensor coupled to each image processing logic block, each sensor in proximity with a display device for detecting test patterns on the display device and providing the representation of the one or more display characteristics to the feedback input port within the image processing logic block; and
a digital video source coupled to each image processing logic block for providing the input image data to the image processing logic block;
wherein each image processing logic block is further configured for generating modified output image data including one or more test patterns, receiving the representation of the one or more display characteristics generated from the display device in response to the one or more test patterns, computing a correction three-dimensional lookup table (3D LUT) based on differences between the one or more display characteristics and the one or more test patterns, and adjusting the modified output image data using the correction 3D LUT.
